(19) United States
(12) Patent Application Publication
(10) Pub. No.: US 2007/0177482 A1
(43) Pub. Date: Aug. 2, 2007

(54) Optical pickup device and optical disc apparatus having the same

(75) Inventors: Yuichi Kamioka, Osaka (JP); Tetsuya Shihara, Osaka (JP); Kenji Nagashima, Osaka (JP); Mitsuyoshi Sasabe, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/700,076

(22) Filed: Jan. 31, 2007

(30) Foreign Application Priority Data
Feb. 2, 2006 (JP) 2006-025476

(51) Int. Cl. G11B 7/00

(52) U.S. Cl. 369/112.02

(57) ABSTRACT

Optical pickup device equipped with liquid crystal diffraction element is provided with liquid crystal diffraction element control portion, which includes detecting portions for detecting light quantities of 0 order light and 1st order light from signal of photo detector for receiving the 0 order light and 1st order light generated by liquid crystal diffraction element, processing portion for determining light quantity ratio of 0 order light to 1st order light from light quantities obtained by detecting portions and for deciding whether or not difference between light quantity ratio and prescribed light quantity ratio is within predetermined range and for determining correction value of voltage to be applied to transparent electrodes if difference is not within predetermined range, and voltage control portion for controlling the voltage value to be applied to transparent electrodes based on process result of processing portion.

This application is based on Japanese Patent Application No. 2006-025476 filed on Feb. 2, 2006, the contents of which is hereby incorporated by reference.

### BACKGROUND OF THE INVENTION

1. Field of the Invention

The present invention relates to an optical pickup device for recording and reproducing information on an optical recording medium by projecting a light beam to the optical recording medium. In particular, the present invention relates to a technique for operating a diffraction element with stable quality, which incorporates liquid crystal disposed in the optical pickup device for obtaining diffracted light. In addition, the present invention relates to an optical disc apparatus having the optical pickup device for realizing such a technique.

2. Description of Related Art

The optical disc apparatus, which records and reproduce information on an optical recording medium such as a compact disc (hereinafter referred to as a CD) and a digital versatile disc (hereinafter referred to as a DVD), is equipped with an optical pickup device for projecting a light beam to the optical recording medium so that information can be recorded and reproduced. An example of a structure of a conventional optical pickup device is shown in FIG. 8.

Numeral 100 denotes an optical pickup device, numeral 2 denotes a semiconductor laser that emits a light beam of a 780 nm band which supports a CD, and numeral 3 denotes a semiconductor laser that emits a light beam of a 650 nm band which supports a DVD. Numeral 4 denotes a dichroic prism that permits a light beam emitted from the light source 2 to pass through and reflects a light beam emitted from the light source 3. Then, the light beams emitted from the light sources 2 and 3 have the same optical axis. Numeral 5 denotes a beam splitter. It permits the light beams emitted from the light sources 2 and 3 to pass through and leads the light beams to an optical recording medium 11, while it reflects a reflection light from the optical recording medium 11 and leads the reflection light to a photo detector 10.

The light beams that were emitted from the light sources 2 and 3 and passed through the beam splitter 5 are converted into parallel rays by a collimator lens 6 and are reflected by an upstand mirror 7 so that its optical axis becomes perpendicular to a recording surface 11a of the optical recording medium 11. Then, the light beams pass through an objective lens 9 via a diffraction element 8 so as to form an image on the recording surface 11a of the optical recording medium 11. At this point the diffraction element 8 has the role of diffracting the incident light beam so that predetermined diffracted light is generated.

The reflection light reflected by the recording surface 11a of the optical recording medium 11 passes through the objective lens 9 and is sent to the diffraction element 8. The diffraction element 8 diffracts the reflection light to as to generate diffracted light (0 order light and ±1st order light), which is reflected by the upstand mirror 7 and passes through the collimator lens 6. Then, the diffracted light is reflected by the beam splitter 5 and is led to the photo detector 10. The photo detector 10 is provided with three light receiving areas (not shown) for receiving the 0 order light and the ±1st order light separately, for example. The 0 order light is used for a reproduction signal, while the 1st order light (±1st order light) is used for a servo error signal for performing a focus control and a tracking control.

In the optical pickup device 100 having the structure described above, the diffraction element 8 is usually a type obtained by forming a predetermined pattern of grooves or the like on a glass or a transparent resin (hereinafter referred to as a solid diffraction element). As described in JP-A-2004-219750, there is one type of the diffraction element, which plays the role as a diffraction grating by using liquid crystal (hereinafter referred to as a liquid crystal diffraction element). Since the liquid crystal diffraction element has an advantage that its function as the diffraction grating can be turned on and off by controlling an applied voltage, the solid diffraction element may be replaced with the liquid crystal diffraction element if necessary.

However, it is known that liquid crystal constituting the liquid crystal diffraction element has characteristics that vary along with a variation of its environment such as a temperature condition. FIG. 9 is a graph that shows a relationship between a voltage to be applied to the liquid crystal and its refractive index at each value of the temperature. As it is understood from this graph, the refractive index obtained by applying a constant voltage to the liquid crystal varies in accordance with the temperature. Therefore, if the temperature varies in the optical pickup device whose optical system includes the liquid crystal diffraction element, a ratio of the 0 order light to the 1st order light obtained by the diffraction of the light beam that passed through the liquid crystal diffraction element is changed, for example. This may become a factor of an unstable system operation of the optical disc apparatus that performs signal processing of the reproduction signal, the servo error signal and the like based on optical information detected by the optical pickup device, so that the optical disc apparatus cannot record and reproduce information with stable quality.

Concerning this point, considering that the liquid crystal changes its characteristics in accordance with its ambient temperature, JP-A-2001-209966 describes about controlling a voltage to be applied to the liquid crystal so that quantity of light received by the light receiving surface of the photo detector of the optical pickup device becomes a maximum value continuously. In addition, JP-A-2000-137926 describes another technique of generating a phase difference for compensating for wave aberration. According to this technique, a thermometer for sensing temperature of the liquid crystal panel is disposed in the optical pickup device that includes the liquid crystal panel for generating the phase difference, and a variation of the characteristics of the liquid crystal panel due to the variation of the sensed temperature is compensated so that the phase difference is generated.

However, as shown in JP-A-2001-209966, it is not ensured that the ratio of the diffracted light can be maintained to a desired value in the optical pickup device in which the liquid crystal diffraction element is arranged to have a predetermined ratio of the 0 order light to the 1st order light, for example, if a voltage to be applied to the liquid crystal is controlled so that quantity of received light becomes a maximum value continuously. Therefore, this method is insufficient for compensating for the variation of the characteristics of the liquid crystal diffraction element along with temperature. In addition, the device described in JP-A-2000-137926 has a structure in which a thermometer is disposed additionally for sensing temperature of the liquid crystal panel, so it has a disadvantage that the number of components increases and that a structure of the optical pickup device becomes complicated.

### SUMMARY OF THE INVENTION

In view of the above described problems, it is an object of the present invention to provide an optical pickup device equipped with a diffraction element made up of liquid crystal for generating predetermined diffracted light, which has a simple structure for recording and reproducing information with stable quality even if characteristics of the liquid crystal vary along with a variation of its environment such as a temperature condition. Further, it is another object of the present invention to provide an optical disc apparatus having high reliability in the quality of recording and reproducing by providing the optical pickup device described above.

To attain the above described object, an optical pickup device according to one aspect of the present invention include: at least one light source; a condensing element for condensing a light beam emitted from the light source on a recording surface of an optical recording medium; a liquid crystal diffraction element disposed between the condensing element and the light source for diffracting incident light beam to generate predetermined diffracted light, the liquid crystal diffraction element including liquid crystal and two transparent electrodes sandwiching the liquid crystal; and a photo detecting portion for receiving reflection light reflected by the optical recording medium, and characterized in that the photo detecting portion receives at least two types of diffracted light having different order numbers of the diffracted light generated by the liquid crystal diffraction element, and a liquid crystal diffraction element control portion is provided for controlling a voltage value to be applied to the transparent electrodes based on a light quantity ratio between the diffracted lights having different order numbers obtained from an electric signal from the photo detecting portion.

Moreover, in the optical pickup device of the present invention having the structure described above, the photo detecting portion receives 0 order light and 1st order light generated by the liquid crystal diffraction element, and the liquid crystal diffraction element control portion includes a 0 order light quantity detecting portion connected to the photo detecting portion for detecting light quantity of the 0 order light, a 1st order light quantity detecting portion connected to the photo detecting portion for detecting light quantity of the 1st order light, a processing portion for determining a light quantity ratio of the 0 order light to the 1st order light from light quantities obtained by the 0 order light quantity detecting portion and the 1st order light quantity detecting portion and for deciding whether or not a difference between the light quantity ratio and a prescribed light quantity ratio that is input as data in advance is within a predetermined range and for determining a correction value of a voltage to be applied to the transparent electrodes if the difference is not within the predetermined range, and a voltage control portion for controlling the voltage value to be applied to the transparent electrodes based on a process result of the processing portion.

Moreover, in the optical pickup device of the present invention having the structure described above, the 0 order light quantity detecting portion and the 1st order light quantity detecting portion detect the light quantities at an interval of a predetermined period of time.

In addition, the present invention provides an optical disc apparatus that is equipped with the optical pickup device having a structure described above.

Moreover, in the optical disc apparatus of the present invention having the structure described above, the liquid crystal diffraction element control portion calculates temperature of the liquid crystal diffraction element based on the light quantity ratio and transmits information of the temperature to at least one other control portion inside the device.

Moreover, in the optical disc apparatus of the present invention having the structure described above, the other control portion is a light source control portion for controlling an output power of the light source.

Further, to attain the above described object, an optical disc apparatus equipped with the optical pickup device according to another aspect of the present invention includes: at least one light source; a condensing element for condensing a light beam emitted from the light source on a recording surface of an optical recording medium; a liquid crystal diffraction element disposed between the condensing element and the light source for diffracting incident light beam to generate predetermined diffracted light, the liquid crystal diffraction element including liquid crystal and two transparent electrodes sandwiching the liquid crystal; and a photo detecting portion for receiving reflection light reflected by the optical recording medium, and characterized in that the photo detecting portion receives 0 order light and 1st order light generated by the liquid crystal diffraction element, and a liquid crystal diffraction element control portion is provided, which includes a 0 order light quantity detecting portion connected to the photo detecting portion for detecting light quantity of the 0 order light, a 1st order light quantity detecting portion connected to the photo detecting portion for detecting light quantity of the 1st order light, a processing portion for determining a light quantity ratio of the 0 order light to the 1st order light from light quantities obtained by the 0 order light quantity detecting portion and the 1st order light quantity detecting portion and for deciding whether or not a difference between the light quantity ratio and a prescribed light quantity ratio that is input as data in advance is within a predetermined range and for determining a correction value of a voltage to be applied to the transparent electrodes if the difference is not within the predetermined range, and a voltage control portion for controlling the voltage value to be applied to the transparent electrodes based on a process result of the processing portion.

According to the first structure of the present invention, even if characteristics of liquid crystal is changed due to an environmental variation such as a temperature condition or the like in the optical pickup device having a diffraction element made up of liquid crystal for generating predetermined diffracted light, it is possible to control the light quantity ratio between orders of the diffracted light among diffracted light generated when the light beam passes through the liquid crystal diffraction element to be substantially constant. Therefore, the optical pickup device that can record and reproduce information with stable quality without being affected by an environmental variation can be provided. In addition, concerning a structure that is hardly affected by an environmental variation, it can be realized by a simple structure without providing an additional temperature sensor or the like.

In addition, according to the second structure of the present invention, in the optical pickup device having the first structure described above, the optical pickup device that can record and reproduce information with stable quality without being affected by an environmental variation can be realized easily with a simple structure.

In addition, according to the third structure of the present invention, in the optical pickup device having the first or the second structure, a characteristics variation of the liquid crystal due to an environmental variation is observed intermittently, and the voltage value to be applied to the transparent electrodes of the liquid crystal diffraction element is also controlled in accordance with the observation result. Therefore, if it is expected that the environmental variation such as a temperature condition is not so large, excessive power consumption can be suppressed by this structure, and it is effective.

In addition, according to the fourth structure of the present invention, in the optical disc apparatus equipped with the optical pickup device having any one of the first to the third structures, the optical disc apparatus having high reliability in quality of recording and reproducing information with a simple structure.

In addition, according to the fifth structure of the present invention, in the optical disc apparatus having the fourth structure described above, it is possible to make the liquid crystal diffraction element play the role as a temperature sensor. Therefore, concerning a component of the optical pickup device that is required to be compensated for a temperature variation other than the liquid crystal diffraction element, it is possible to compensate for the temperature variation without adding a temperature sensor. Thus, the optical disc apparatus can be made in a simple structure.

In addition, according to the sixth structure of the present invention, in the optical disc apparatus having the fifth structure described above, it is possible to compensate for influence of temperature variation in the light source without adding a temperature sensor. In particular, since the semiconductor laser is vulnerable to the temperature variation, a large effect can be obtained if a semiconductor laser is used as the light source.

According to the seventh structure of the present invention, even if characteristics of the liquid crystal varies due to a variation of its environment such as a temperature condition in the optical disc apparatus equipped with an optical pickup device having a diffraction element made up of liquid crystal for generating predetermined diffracted light, it is possible to control the light quantity ratio of the 0 order light to the 1st order light generated as a result of diffraction by the liquid crystal diffraction element to be substantially constant. Therefore, it is possible to obtain the optical disc apparatus having high reliability in quality of recording and reproducing information without being affected by the environmental variation. In addition, the structure for maintaining the light quantity ratio of the 0 order light to the 1st order light to be substantially constant despite of the environmental variation can be realized by a simple structure without adding a temperature sensor or the like.

### BRIEF DESCRIPTION OF THE DRAWINGS

FIG. 1 is a block diagram to show a structure of an optical disc apparatus according to a first embodiment.

FIG. 2 is a schematic diagram for explaining a structure of a liquid crystal diffraction element of an optical pickup device that is provided to the optical disc apparatus according to the first embodiment.

FIGS. 3A and 3B are schematic diagrams for explaining an action of the liquid crystal diffraction element of the optical pickup device that is provided to the optical disc apparatus according to the first embodiment.

FIG. 4 is a block diagram to show a structure of a liquid crystal diffraction element control portion that is provided to the optical disc apparatus according to the first embodiment.

FIG. 5 is a flowchart to show a process of controlling a voltage to be applied to a transparent electrode performed by a liquid crystal diffraction element control portion that is provided to the optical disc apparatus according to the first embodiment.

FIG. 6 is a block diagram to show a structure of an optical pickup device according to a second embodiment.

FIG. 7 is a diagram to show a variation of the structure of a liquid crystal diffraction element of an optical pickup device that is provided to the optical disc apparatus according to the second embodiment.

FIG. 8 is a schematic diagram to show a structure of an optical system of a conventional optical pickup device.

FIG. 9 is a graph that shows a relationship between a voltage to be applied to the liquid crystal and its refractive index at each value of the temperature.

### DESCRIPTION OF THE PREFERRED EMBODIMENTS

Now, embodiments of the present invention will be described with reference to the attached drawings. The embodiments described below are merely examples, and the present invention is not limited to these embodiments.

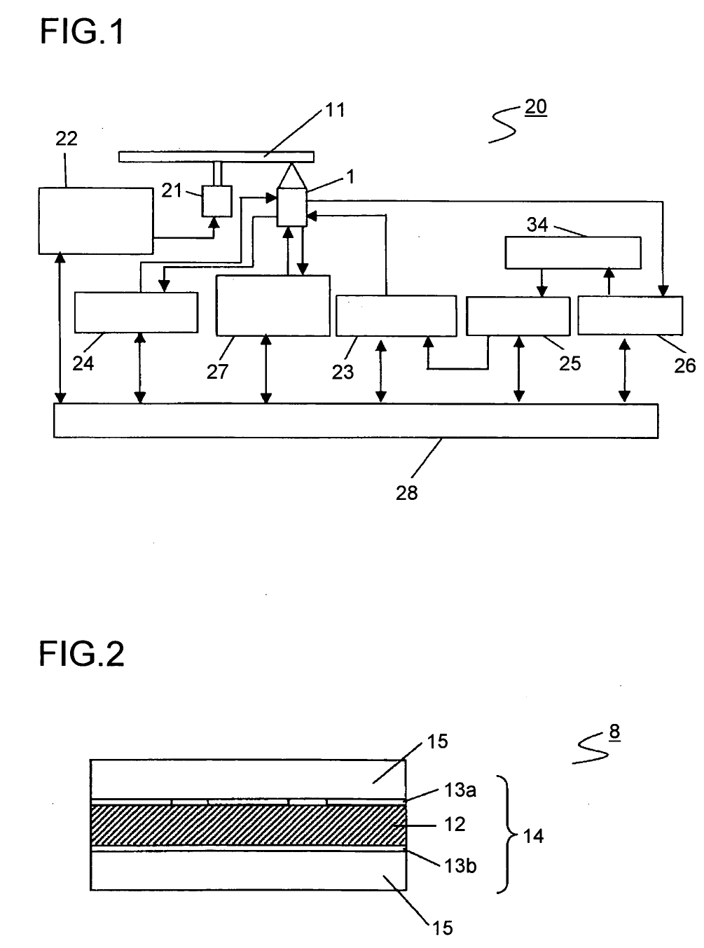

FIG. 1 is a block diagram to show a structure of a first embodiment of an optical disc apparatus having an optical pickup device including a liquid crystal diffraction element control portion according to the present invention. An optical disc apparatus 20 can reproduce information from an optical recording medium 11 and record information on the optical recording medium 11. Numeral 21 denotes a spindle motor, and the optical recording medium 11 is retained in a detachable manner by a chucking portion (not shown) that is provided to the upper portion of the spindle motor 21. When information is recorded or reproduced on the optical recording medium 11, the spindle motor 21 rotates the optical recording medium 11 continuously. A rotation control of the spindle motor 21 is performed by a spindle motor control portion 22.

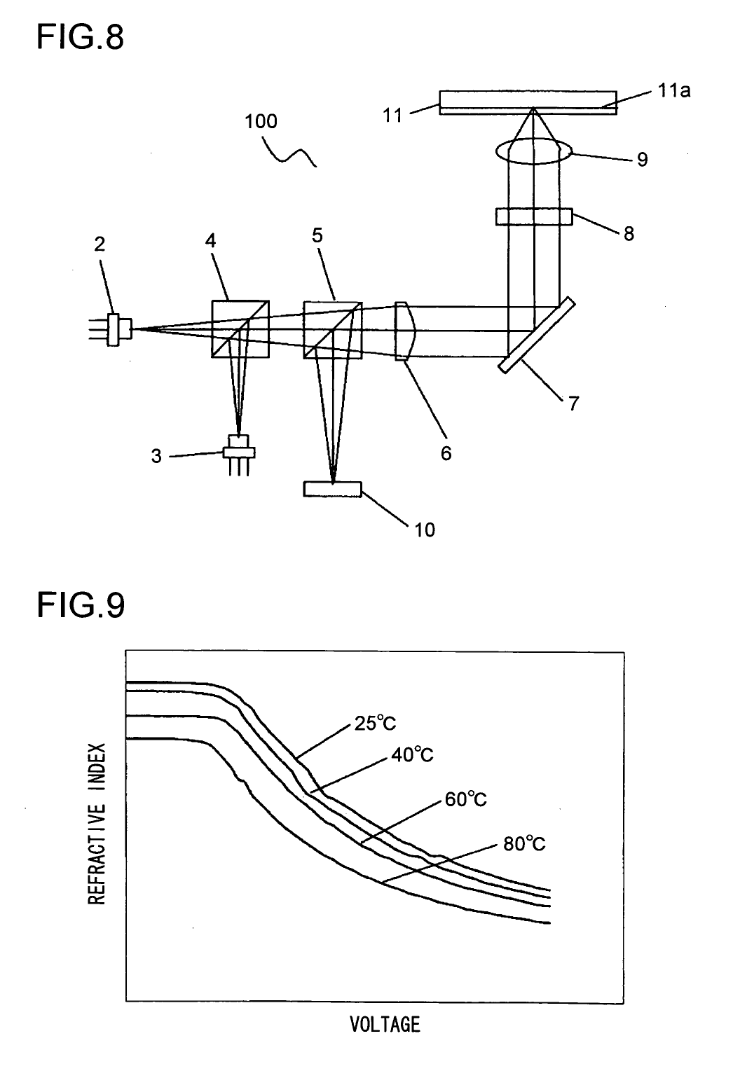

Numeral 1 denotes the optical pickup device, which projects a light beam emitted from the light source to the optical recording medium 11 so that information can be recorded on the optical recording medium 11 and that information recorded on the optical recording medium 11 can be reproduced. A structure of an optical system of the optical pickup device 1 is basically the same as that of the conventional optical pickup device 100 shown in FIG. 8, so the same elements are denoted by the same reference numerals, and descriptions thereof will be omitted except for the case where the description is necessary.

A diffraction element 8 provided to the optical pickup device 1 is a liquid crystal diffraction element that is made up of liquid crystal. FIG. 2 is a schematic diagram for explaining a structure of the liquid crystal diffraction element 8 of the optical pickup device 1 according to the present embodiment. As shown in FIG. 2, the liquid crystal diffraction element 8 is made up of liquid crystal 12, two transparent electrodes 13a and 13b sandwiching the liquid crystal 12, and two glass plates 15 sandwiching a body 14 consisting of the liquid crystal 12 and the transparent electrodes 13a and 13b.

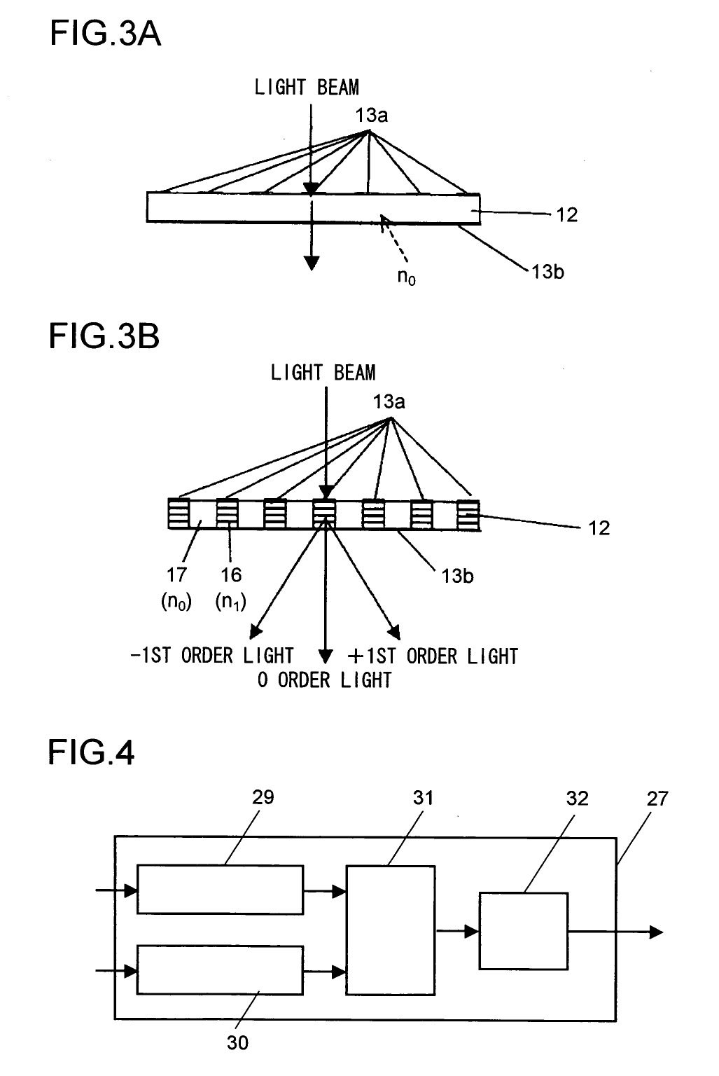

One transparent electrode 13a out of the transparent electrodes 13a and 13b is patterned so that the light beam for a CD and a DVD generates predetermined diffracted light. In contrast, the other transparent electrode 13b is a common electrode as a whole without being patterned. Two states where a voltage to be applied to the transparent electrodes 13a and 13b are on and off are shown schematically in FIGS. 3A and 3B, respectively. FIG. 3A shows the state where the voltage is not applied, and FIG. 3B shows the state where the voltage is applied. At this point the glass plates 15 are omitted in FIGS. 3A and 3B.

When the voltage is not applied to the transparent electrodes 13a and 13b, the refractive index of the liquid crystal 12 is the same value (n0) in any part. In contrast, when the voltage is applied to the transparent electrodes 13a and 13b, the refractive index of a part 16 where the patterned transparent electrode 13a presents changes from n0 to n1. Therefore, the part 16 with the transparent electrode 13a and a part 17 without the same have different values of the refractive index. As a result, the light beam passing through the liquid crystal diffraction element 8 generates diffracted light (0 order light and 1st order light). Furthermore, the transparent electrodes 13a and 13b are connected electrically to the voltage control portion (not shown), which controls the voltage to be applied to the transparent electrodes 13a and 13b. The control of the applied voltage performed by the voltage control portion will be described later.

Although the optical pickup device 1 of the optical disc apparatus 20 supports a CD and a DVD in the first embodiment, this structure should not be interpreted in a limiting manner and can be modified variously within the scope of the present invention. For example, it is possible that the optical pickup device supports only one type of the optical recording medium 11 such as a DVD or a blue-laser DVD that is a high density optical recording medium. Alternatively, the optical pickup device may support a DVD and a blue-laser DVD corresponding to two wavelengths, or it may support optical recording media corresponding to three or more wavelengths.

With reference to FIG. 1 again, the optical disc apparatus 20 is equipped with a laser control portion 23, a servo control portion 24, a record control portion 25, a reproduction control portion 26, and a liquid crystal diffraction element control portion 27. At this point these control portions 23-27 and the spindle motor control portion 22 described above are connected to the system control portion 28 that controls the whole system. Hereinafter, each of the control portions 23-27 will be described.

The laser control portion 23 controls each output power of the laser beams emitted from the semiconductor lasers that are the light sources 2 and 3 (see FIG. 8) of the optical pickup device 1. In addition, the laser control portion 23 is connected to the record control portion 25, and the operation of the laser control portion 23 is controlled by a signal from the record control portion 25. The record control portion 25 will be described later.

The servo control portion 24 performs servo control that includes focusing control and tracking control in the optical pickup device 1. In the present embodiment, a focus error signal and a tracking error signal are generated based on electric signal light obtained in a light receiving area (not shown) for receiving 1st diffracted light that is provided to a photo detector 10. Then, a drive signal is supplied to an actuator (not shown) of the optical pickup device 1, on which the liquid crystal diffraction element 8 and the objective lens 9 (see FIG. 8 for both) are mounted. The actuator supplied with the drive signal activates each portion based on the signal, so as to perform the focusing control for adjusting the focus by moving the objective lens 9 in the direction parallel with the optical axis and the tracking control for adjusting a position of a light beam spot to follow a track formed on the optical recording medium 11 by moving the objective lens 9 in the radial direction of the optical recording medium 11.

The record control portion 25 plays the role of modulating information data input from an external device (not shown) such as a personal computer via an interface 34 by the modulation circuit (not shown) and transmitting the modulated data signal to the laser control portion 23.

The reproduction control portion 26 demodulates the modulated information of the electric signal of the 0 order light, for example, detected by the photo detector 10 (see FIG. 8) of the optical pickup device 1 into the original state by the demodulation circuit (not shown) so that the reproduction signal is generated. Then, the generated reproduction signal is transmitted to an external device such as a personal computer via the interface 34.

The liquid crystal diffraction element control portion 27 plays the role of controlling the voltage to be applied to the transparent electrodes 13a and 13b of the liquid crystal diffraction element 8 that is provided to the optical pickup device 1. FIG. 4 is a block diagram to show a structure of the liquid crystal diffraction element control portion 27. As shown in FIG. 4, the liquid crystal diffraction element control portion 27 includes a 0 order light quantity detecting portion 29, a 1st order light quantity detecting portion 30, a processing portion 31 and a voltage control portion 32.

The 0 order light quantity detecting portion 29 and the 1st order light quantity detecting portion 30 are connected to the photo detector 10 of the optical pickup device 1, so as to receive electric signals of the 0 order light and the 1st order light detected by the photo detector 10. Then, they detect quantity of the 0 order light and quantity of 1st order light. The 0 order light quantity detecting portion 29 and the 1st order light quantity detecting portion 30 are connected to the processing portion 31.

The processing portion 31 receives information about light quantity obtained by the 0 order light quantity detecting portion 29 and the 1st order light quantity detecting portion 30, and it calculates a ratio of the quantity of the 0 order light to the quantity of the 1st order light based on the information. In addition, the processing portion 31 plays the role of comparing an optimal light quantity ratio stored as data in advance (hereinafter referred to as a prescribed light quantity ratio) with the real measurement value of the light quantity ratio that was determined before, and deciding whether or not the voltage value that is applied to the transparent electrodes 13a and 13b of the liquid crystal diffraction element 8 should be corrected, and further calculating an correction value of the voltage value if the correction is necessary. The processing portion 31 is connected to the voltage control portion 32.

The voltage control portion 32 play the role of controlling whether or not a voltage should be applied to the liquid crystal diffraction element 8 in accordance with the information from the system control portion 28 (see FIG. 1) and adjusting a value of the applied voltage in accordance with a process result of the processing portion 31. This voltage control portion 32 is connected to the transparent electrodes 13a and 13b (see FIG. 2) of the liquid crystal diffraction element 8.

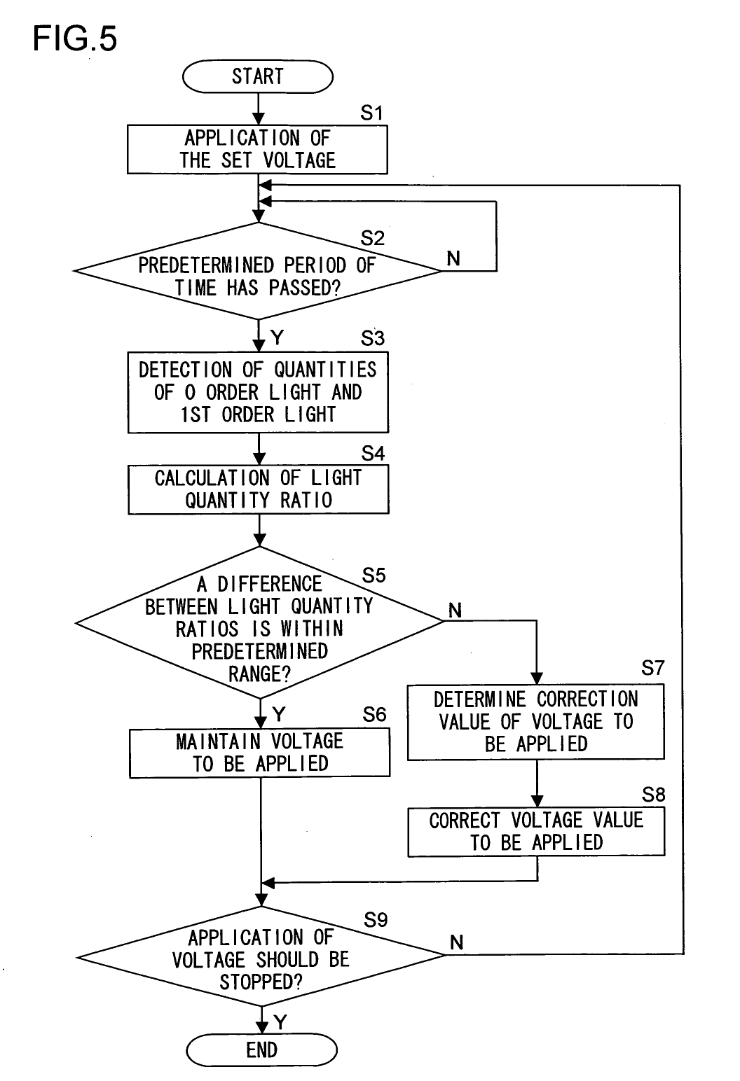

Next, the process of the liquid crystal diffraction element control portion 27 having the structure described above for controlling the transparent electrodes 13a and 13b of the liquid crystal diffraction element 8 will be described. FIG. 5 shows a flowchart of a process of the liquid crystal diffraction element control portion 27 for controlling a voltage to be applied to the transparent electrodes 13a and 13b. Hereinafter, the process of the liquid crystal diffraction element control portion 27 will be described with reference to this flowchart.

When the optical disc apparatus 20 is turned on, the voltage control portion 32 applies a voltage at a preset value between the transparent electrodes 13a and 13b so that the liquid crystal diffraction element 8 of the optical pickup device 1 also works in accordance with an instruction from the system control portion 28 (Step S1). Then, it is checked by the system control portion 28 whether or not a predetermined period of time has passed from the application of the voltage between the transparent electrodes 13a and 13b, for example (Step S2). At this point it is possible to check whether or not the predetermined period of time has passed by the 0 order light quantity detecting portion 29 and the 1st order light quantity detecting portion 30 instead of the system control portion 28.

If the predetermined period of time has passed, the 0 order light quantity detecting portion 29 and the 1st order light quantity detecting portion 30 detect respectively quantity of the 0 order light and quantity of the 1st order light detected by the photo detector 10 (see FIG. 8) (Step S3). In contrast, if the predetermined period of time has not passed, the 0 order light quantity detecting portion 29 and the 1st order light quantity detecting portion 30 do not detect quantity of the 0 order light and quantity of the 1st order light until the predetermined period of time has passed.

When the 0 order light quantity detecting portion 29 and the 1st order light quantity detecting portion 30 detect quantity of the 0 order light and quantity of the 1st order light, the processing portion 31 calculates the light quantity ratio of the 0 order light to the 1st order light (Step S4). When this light quantity ratio is calculated, the processing portion 31 compares the calculated light quantity ratio with the prescribed light quantity ratio stored as data in advance, and it determines whether or not a difference between the calculated light quantity ratio and the prescribed light quantity ratio is within a predetermined range (Step S5).

If the difference between the light quantity ratios is within the predetermined range, the voltage control portion 32 maintains the voltage value to be applied between the transparent electrodes 13a and 13b without changing it (Step S6). On the contrary, if the difference between the light quantity ratios is not within the predetermined range, the processing portion 31 determines a correction value of the voltage to be applied between the transparent electrodes 13a and 13b based on data (e.g., data about a relationship between the light quantity ratio and temperature under the condition where the voltage to be applied between the transparent electrodes 13a and 13b is constant, or data about a relationship between temperature and the voltage to be applied between the transparent electrodes 13a and 13b under the condition of the prescribed light quantity ratio) that is stored in advance for correcting the voltage value to be applied between the transparent electrodes 13a and 13b (Step S7).

At this point this correction value may be a voltage value to be applied newly or a value to be added to the voltage value before correction. In addition, the data stored in advance for calculating the correction value is not limited to the temperature data but may include humidity or other environmental data.

When the correction value of the voltage to be applied between the transparent electrodes 13a and 13b is determined, the voltage control portion 32 corrects the voltage value to be applied between the transparent electrodes 13a and 13b (Step S8). After that, the system control portion 28 decides whether or not the application of the voltage between the transparent electrodes 13a and 13b of the liquid crystal diffraction element 8 should be stopped (Step S9). If it is decided that the application of the voltage should be stopped, the voltage control portion 32 stops the application of the voltage between the transparent electrodes 13a and 13b. If it is decided to continue the application of the voltage, it is decided again whether a predetermined period of time has passed after the quantity of the 0 order light and the 1st order light is detected (Step S2), and the process from the step S3 to the step S9 is repeated.

At this point the method of controlling the voltage to be applied between the transparent electrodes 13a and 13b of the liquid crystal diffraction element 8 performed by the liquid crystal diffraction element control portion 27 is not limited to the method of the present embodiment described above. The method of the present embodiment can be modified variously within the scope of the present invention. For example, although the prescribed light quantity ratio is compared with the light quantity ratio detected at an interval of the predetermined period of time in the present embodiment, it is possible to compare the light quantity ratios continuously instead of the interval of the predetermined period of time and to correct the voltage to be applied between the transparent electrodes 13a and 13b promptly when a difference between the light quantity ratios is detected.

Next, an optical disc apparatus according to a second embodiment of the present invention will be described, which includes an optical pickup device provided with the liquid crystal diffraction element control portion of the present invention. The structure of the optical disc apparatus of the second embodiment is basically the same as the structure of the optical disc apparatus 20 of the first embodiment, so only the different points will be described.

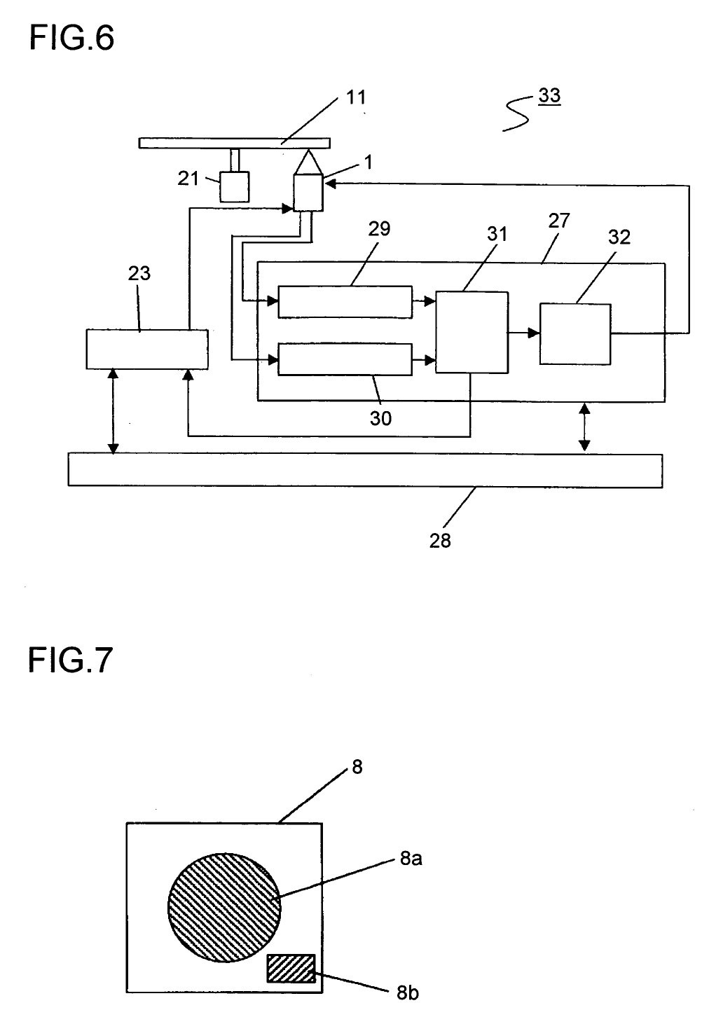

FIG. 6 is a block diagram to show the structure of the optical disc apparatus 33 according to the second embodiment. At this point in FIG. 6 the spindle motor control portion 22, the servo control portion 24, the record control portion 25, and the reproduction control portion 26 that are the same as in the case of FIG. 1 are omitted. The optical disc apparatus 33 are different from the optical disc apparatus 20 of the first embodiment in that the liquid crystal diffraction element control portion 27 is connected to the laser control portion 23. More specifically, an electric signal is transmitted from the processing portion 31 in the liquid crystal diffraction element control portion 27 to the laser control portion 23.

The processing portion 31 in the present embodiment play the role of deciding whether or not a difference between the detected light quantity ratio and the prescribed light quantity ratio is within a predetermined range like the case of the first embodiment. If it is not within the predetermined range, the processing portion 31 determines the correction value of the voltage to be applied between the transparent electrodes 13a and 13b (see FIG. 2 for both) of the liquid crystal diffraction grating 8, and it transmits the information data thereof to the voltage control portion 32. In addition to this role, the processing portion 31 plays the role of calculating temperature of the liquid crystal diffraction element 8 (see FIGS. 2 and 8) from the detected light quantity ratio and transmitting the calculated temperature as an electric signal to the laser control portion 23.

The method of determining the temperature includes, for example, storing experimental data obtained by changing a reference of the voltage about a relationship between the light quantity ratio and the temperature when the voltage to the applied between the transparent electrodes 13a and 13b is constant in the processing portion 31 in advance as data, and determining the temperature based on the stored data from a detected light quantity ratio and a voltage that is applied between the transparent electrodes 13a and 13b at that point of time.

The laser control portion 23 that received the temperature data from the processing portion 31 uses the temperature data for controlling the output power of the light beam emitted from the light sources 2 and 3 to be stable without being affected by temperature variation. The semiconductor laser of the light sources 2 and 3 (see FIG. 8) is vulnerable to the temperature variation. Although a temperature sensor such as a thermistor is usually used for sensing temperature at a vicinity of the optical pickup device 1, the liquid crystal diffraction element 8 plays the role of the temperature sensor for sensing temperature around the optical pickup device 1 in the optical disc apparatus 33 of the present embodiment. Therefore, the optical disc apparatus 33 can be configured in a simple structure without an additional temperature sensor.

Although the processing portion 31 calculates temperature of the liquid crystal diffraction element 8 in the present embodiment, other structure may be adopted, in which other portion calculates the temperature. Furthermore, the present embodiment utilizes the diffracted light (the 0 order light and the 1st order light) obtained from the diffraction grating provided to the liquid crystal diffraction element 8 for obtaining the reproduction signal and the servo signal so that the processing portion 31 calculates temperature of the liquid crystal diffraction element 8, which is used as a temperature sensor for sensing temperature around the optical pickup device 1. However, the present invention is not limited to this structure. For example, as shown in FIG. 7, it is possible to form another diffraction grating 8b on the liquid crystal diffraction element 8 for obtaining the reproduction signal or the like as a temperature sensor of the optical pickup device 1 separately from the diffraction grating 8a.

Although temperature of the liquid crystal diffraction element 8 obtained by the liquid crystal diffraction element control portion 27 is transmitted to the laser control portion 23 in the present embodiment, the present invention is not limited to this structure. It is possible that if there is a component of the optical pickup device 1 that is controlled by a control portion about compensation for temperature influence, temperature of the liquid crystal diffraction element 8 obtained by the liquid crystal diffraction element control portion 27 is transmitted also to the control portion of the component.

Although the light quantity ratio of the 0 order light to the 1st order light obtained by the liquid crystal diffraction element 8 is used for compensating for influence of an environmental variation to the liquid crystal diffraction element 8 in the first and the second embodiments, the present invention is not limited to this structure. It is possible to use a light quantity ratio between diffracted light of higher order than the 1st order light and the 0 order light for the compensation.

Furthermore, although the liquid crystal diffraction element 8 of the optical pickup device 1 is used as a diffraction element for performing the focus control and the tracking control in the first and the second embodiments, the present invention is not limited to this structure. For example, the present invention can also be applied to an optical pickup device or the like having a structure in which the liquid crystal diffraction element 8 is used only for the tracking control. Moreover, the optical disc apparatus provided with the optical pickup device including the liquid crystal diffraction element control portion of the present invention is a writable and readable device in the first and the second embodiments. However, the present invention can also be applied to an optical disc apparatus of a read only type.

The present invention is applied to an optical pickup device that includes at least one light source, a condensing element for condensing a light beam emitted from the light source on a recording surface of an optical recording medium, a liquid crystal diffraction element disposed between the condensing element and the light source for diffracting incident light beam to generate predetermined diffracted light, the liquid crystal diffraction element including liquid crystal and two transparent electrodes sandwiching the liquid crystal, and a photo detecting portion for receiving reflection light reflected by the optical recording medium. The photo detecting portion receives at least two types of diffracted light having different order numbers of the diffracted light generated by the liquid crystal diffraction element, and a liquid crystal diffraction element control portion is provided for controlling a voltage value to be applied to the transparent electrodes based on a light quantity ratio between the diffracted light having different order numbers obtained from an electric signal from the photo detecting portion.

Therefore, even if characteristics of liquid crystal is changed due to an environmental variation such as a temperature condition or the like in the optical pickup device having a diffraction element made up of liquid crystal for generating predetermined diffracted light, it is possible to control the light quantity ratio between diffracted light having different orders that are generated when the light beam passes through the liquid crystal diffraction element to be substantially constant. Therefore, the optical pickup device that can record and reproduce information with stable quality without being affected by an environmental variation can be provided. In addition, concerning a structure that is hardly affected by an environmental variation, it can be realized by a simple structure without providing an additional temperature sensor or the like.

In addition, in the optical pickup device described above, the photo detecting portion receives 0 order light and 1st order light generated by the liquid crystal diffraction element, and the liquid crystal diffraction element control portion includes a 0 order light quantity detecting portion connected to the photo detecting portion for detecting light quantity of the 0 order light, a 1st order light quantity detecting portion connected to the photo detecting portion for detecting light quantity of the 1st order light, a processing portion for determining a light quantity ratio of the 0 order light to the 1st order light from light quantities obtained by the 0 order light quantity detecting portion and the 1st order light quantity detecting portion and for deciding whether or not a difference between the light quantity ratio and a prescribed light quantity ratio that is input as data in advance is within a predetermined range and for determining a correction value of a voltage to be applied to the transparent electrodes if the difference is not within the predetermined range, and a voltage control portion for controlling the voltage value to be applied to the transparent electrodes based on a process result of the processing portion.

Thus, the optical pickup device that can record and reproduce information with stable quality without being affected by an environmental variation can be realized easily in a simple structure.

In addition, since the optical disc apparatus is equipped with the optical pickup device described above, it is possible to obtain the optical disc apparatus having high reliability in quality of record and reproduction with a simple structure.

In addition, in the optical pickup device described above, the liquid crystal diffraction element control portion calculates temperature of the liquid crystal diffraction element based on the light quantity ratio and transmits information of the temperature to at least one other control portion inside the device. Thus, it is possible to make the liquid crystal diffraction element play a role as a temperature sensor. As a result, concerning a component of the optical pickup device that is required to be compensated for a temperature variation other than the liquid crystal diffraction element, it is possible to compensate for the temperature variation without adding a temperature sensor. Therefore, the optical disc apparatus can be made in a simple structure.

What is claimed is:

1. An optical pickup device comprising:
at least one light source;
a condensing element for condensing a light beam emitted from the light source on a recording surface of an optical recording medium;
a liquid crystal diffraction element disposed between the condensing element and the light source for diffracting incident light beam to generate predetermined diffracted light, the liquid crystal diffraction element including liquid crystal and two transparent electrodes sandwiching the liquid crystal; and
a photo detecting portion for receiving reflection light reflected by the optical recording medium, wherein
the photo detecting portion receives at least two types of diffracted light having different order numbers of the diffracted light generated by the liquid crystal diffraction element, and
a liquid crystal diffraction element control portion is provided for controlling a voltage value to be applied to the transparent electrodes based on a light quantity ratio between the diffracted light having different order numbers obtained from an electric signal from the photo detecting portion.

2. The optical pickup device according to claim 1, wherein
the photo detecting portion receives 0 order light and 1st order light generated by the liquid crystal diffraction element, and
the liquid crystal diffraction element control portion includes a 0 order light quantity detecting portion connected to the photo detecting portion for detecting light quantity of the 0 order light, a 1st order light quantity detecting portion connected to the photo detecting portion for detecting light quantity of the 1st order light, a processing portion for determining a light quantity ratio of the 0 order light to the 1st order light from light quantities obtained by the 0 order light quantity detecting portion and the 1st order light quantity detecting portion and for deciding whether or not a difference between the light quantity ratio and a prescribed light quantity ratio that is input as data in advance is within a predetermined range and for determining a correction value of a voltage to be applied to the transparent electrodes if the difference is not within the predetermined range, and a voltage control portion for controlling the voltage value to be applied to the transparent electrodes based on a process result of the processing portion.

3. The optical pickup device according to claim 2, wherein the 0 order light quantity detecting portion and the 1st order light quantity detecting portion detect the light quantities at an interval of a predetermined period of time.

4. An optical disc apparatus that is equipped with the optical pickup device according to claim 1.

5. The optical disc apparatus according to claim 4, wherein the liquid crystal diffraction element control portion calculates temperature of the liquid crystal diffraction element based on the light quantity ratio and transmits information of the temperature to at least one other control portion inside the device.

6. The optical disc apparatus according to claim 5, wherein the other control portion is a light source control portion for controlling an output power of the light source.

7. An optical disc apparatus equipped with the optical pickup device comprising:
at least one light source;
a condensing element for condensing a light beam emitted from the light source on a recording surface of an optical recording medium;
a liquid crystal diffraction element disposed between the condensing element and the light source for diffracting incident light beam to generate predetermined diffracted light, the liquid crystal diffraction element including liquid crystal and two transparent electrodes sandwiching the liquid crystal; and
a photo detecting portion for receiving reflection light reflected by the optical recording medium, wherein
the photo detecting portion receives 0 order light and 1st order light generated by the liquid crystal diffraction element, and
a liquid crystal diffraction element control portion is provided, which includes a 0 order light quantity detecting portion connected to the photo detecting portion for detecting light quantity of the 0 order light, a 1st order light quantity detecting portion connected to the photo detecting portion for detecting light quantity of the 1st order light, a processing portion for determining a light quantity ratio of the 0 order light to the 1st order light from light quantities obtained by the 0 order light quantity detecting portion and the 1st order light quantity detecting portion and for deciding whether or not a difference between the light quantity ratio and a prescribed light quantity ratio that is input as data in advance is within a predetermined range and for determining a correction value of a voltage to be applied to the transparent electrodes if the difference is not within the predetermined range, and a voltage control portion for controlling the voltage value to be applied to the transparent electrodes based on a process result of the processing portion.
